(19) United States
(12) Patent Application Publication
(10) Pub. No.: US 2005/0146280 A1
(43) Pub. Date: Jul. 7, 2005

(54) Method and apparatus for the reduction of electromagnetic radiation from display screens

(75) Inventors: Antony van De Ven, Hong Kong (HK); Curie Kui-Lai Chan, Hong Kong (HK)

Correspondence Address: JACOBSON HOLMAN PLLC, 400 SEVENTH STREET N.W., SUITE 600, WASHINGTON, DC, 20004, US

(73) Assignee: Lighthouse Technologies Ltd.

(21) Appl. No.: 10/719,983

(22) Filed: Nov. 24, 2003

Related U.S. Application Data
(63) Continuation of application No. 10/014,794, filed on Dec. 14, 2001, now abandoned.

(51) Int. Cl. G09G 3/10

(52) U.S. Cl. 315/169.3

(57) ABSTRACT

This invention relates to a method and apparatus for the reduction of electromagnetic radiation from display screens. The display screen is substantially encased within a conductive shield formed by the housing around the display screen, a rear housing and a conductive coating or layer over the front face of a PCB panel on which light-emitting elements may be mounted. Interconnections are provided between all the components of the shield so as to limit any gaps within the shield to a size sufficiently small to minimize damaging electromagnetic noise.

### FIELD OF THE INVENTION

This invention relates to a method and apparatus for the reduction of electromagnetic radiation from display screens and, in particular, panels of display screens containing a plurality of light-emitting elements driven by high frequency driving signals.

### BACKGROUND TO THE INVENTION

Many display screens, particularly those that may be provided in the form of a plurality of interconnected panels for large display screen installations, emit substantial electromagnetic radiation. One of the principal causes of the radiation is the provision of high frequency pulse width modulated signals for the control of the intensity to the individual LEDs. The substantially square wave nature of the pulse width modulated signal at a relatively high frequency of, for example, 1,024 pulses in less than 1/60^{th} of a second, can cause problems with the emission of large amounts of electromagnetic radiation or noise. This electromagnetic noise may be a substantial hazard to the operation of other electronic equipment.

In a typical panel for a large display screen, a printed circuit board (PCB) carrying a plurality of light emitting elements such as LEDs may carry the LEDs on a front face with the driving circuitry on a reverse face. To provide a suitable display, it is not possible to provide a radiation shield across the front of the display that will detract from the visual aspects of the display itself.

The PCBs are often mounted in moulded plastic housings surrounding the perimeter of the PCB. The plastic housings can then be connected to back covers with the back cover often being made of metal.

One method of containing an electromagnetic radiation is recognized in providing a metallic shield to substantially enclose the source of the radiation with only small gaps provided through the shield. Provided no aperture through the shield is greater than, for example, a few millimeter in its largest dimension, the worst of the noise can be contained. Although the metal back cover protects the back of the unit from emitting such radiation, the radiation readily escapes from the PCB front face or through the plastic housing surrounding the PCB. The difficulty resides in providing such protection for the plastic housings and across the front face of the PCB.

### OBJECT OF THE INVENTION

It is an object of the present invention to provide a method and apparatus for shielding display screens to reduce the electromagnetic radiation that will overcome some of the disadvantages of the prior art by providing a suitable shield to the front face of the display and around any perimeter of the display panel.

### SUMMARY OF THE INVENTION

Accordingly, in a first aspect, the invention may broadly be said to consist in a display screen comprising:
a printed circuit board (PCB) having a front face and a rear face;
a plurality of light emitting elements mounted on said PCB to reside on the front face of the PCB and provide a display;
control circuitry mounted directly or indirectly to said printed circuit board to drive said light emitting elements;
a layer of material conductive to electromagnetic radiation provided on a front face of said PCB to cover a substantial portion of said front face and positioned between said PCB and the light emitting portions of said light emitting elements;
a plurality of conductivity isolated areas in said layer to allow isolated connections from said light emitting elements to said PCB; and
a housing mounted around a perimeter of said PCB and extending around said driving circuitry containing material conductive to electromagnetic radiation to substantially enclose said driving circuitry within said housing and said layer,

Accordingly, in a second aspect, the invention may broadly be said to consist in a method of reducing electromagnetic radiation from a display screen comprising:
providing a layer of electromagnetic conductive material on a front face of a printed circuit board used for mounting light emitting elements;
providing a plurality of electrically isolated points in or through said layer for the connection of said light emitting elements to said printed circuit board; and
surrounding a rear face of said printed circuit board with an electromagnetic conductive housing so as to substantially enclose driving circuitry behind the printed circuit board and the circuit board itself within a shield formed by said housing and said layer.

### BRIEF DESCRIPTION OF THE DRAWINGS

Preferred embodiments of this invention will now be described with reference to the following drawings in which:

FIG. 1 shows an elevational view of a portion of a printed circuit board in accordance with one embodiment of this invention;

FIG. 2 shows a cross-sectional view through a portion of a display screen in accordance with an embodiment of the invention; and

FIG. 3 shows a detailed cross-sectional view through a component of the apparatus of FIG. 2.

### DETAILED DESCRIPTION OF PREFERRED EMBODIMENTS

The nature of display screens, particularly those that operate with digital data provided to light emitting elements in the form of pulse width modulated signals, can generate substantial quantities of electromagnetic radiation.

The square pulse nature of a pulse width modulated signal to the light emitting elements is particularly severe in the production of electromagnetic noise that may disrupt other electrical or electronic equipment.

As with all electronic equipment that produces electromagnetic radiation, various standards are in place to limit the amount of radiation permitted.

The traditional method of dealing with electromagnetic radiation is to either limit the production of that radiation or to shield the radiation to prevent it transmitting externally from the item.

Limiting electromagnetic waves emitting from such display apparatus may be difficult given the nature of the high frequency pulse width modulated signals used to drive the display. Although the noise may be reduced, it may still exceed permitted or desired levels and may require the inclusion of numerous

Shielding against such radiation usually involves housing the apparatus within material that can conduct the electromagnetic radiation. Typically, this involves entirely enclosing the apparatus within a metal surround. Although apertures can be provided, the dimension of the apertures through the shield needs to be kept small to limit the maximum wavelength that could be transmitted through such an aperture. Hence apertures need to be limited by their maximum dimension in any direction.

Display screens 1 of a type in accordance with the preferred embodiment use a printed circuit board 2 (PCB) having a front face and a rear face. Light emitting elements may be connected to reside on the front face 3 of the PCB 2. It will be appreciated that the driving circuitry will reside behind a rear face 4 of the PCB 2 so as to be operatively connected to the light emitting elements.

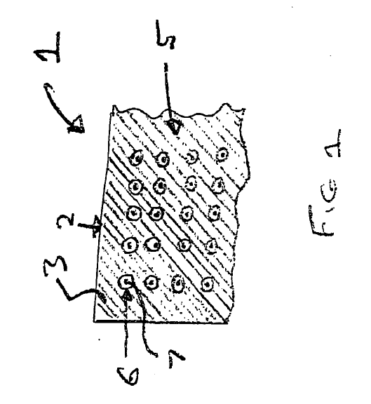

As shown in FIG. 1, a particular PCB 2 is shown having a layer or coating 5 an the front face 3 of the PCB. This coating may be a metallic coating such as copper or any other metallic or electromagnetic conductive material so as to provide the shielding necessary through the front face of the screen.

With light emitting elements residing on the front face 3 of the PCB and connected to driving circuitry generally held behind the PCB 2, it is necessary to provide a plurality of apertures 6 in the coating surrounding connection points 7 for the light emitting elements. The connection points 7 may be apertures through the PCB 2 so as to connect the light-emitting element to a circuit contained on rear face 4 of the PCB 2. If desired, a light-emitting element typically have more than a single leg may have one or more legs connected to the coating or in unisolated areas. The coating could provide a common ground or earth for one side of an LED or similar with only the remaining leg or legs requiring isolated connection.

As it is necessary to provide a coating that can shield the electromagnetic radiation and such materials for a layer such as a coating, sheet that may be placed in that position are also conductive, the apertures 6 provide an electrically isolated point for connection of the LED or other light emitting element to the PCB 2 without interconnecting the light emitting elements through the coating 5. Small apertures necessary to surround a point of connection 7 would only allow passage of such small wavelengths as to greatly decrease the overall electromagnetic radiation from the, unit

Thus far the description has often referred to a coating 5. It will be appreciated that a coating may be a preferred form of layer as this can be relatively easily laid onto the PCB 2 and the apertures in the coating 6 can be formed during the coating process or etched subsequently. Either masking prior to applying the coating or removing the coating in the region of the apertures may be used.

Although generally referring to a coating 5, a separate sheet of material could also be used to provide the layer. Such a sheet or layer can surround the light emitting elements or be placed between the light emitting elements and the PCB 2 provided it has apertures necessary to electrically isolate the connectors for the light-emitting elements to the circuit on the PCB 2. Usually the circuit will be on the reverse side of the PCB and the light-emitting elements will pass through the PCB to be connected to a circuit of the reverse side 4.

To provide a useful shield, it is necessary to substantially enclose the emissions in 3-dimensions. Therefore, the housing around the circuitry on the reverse side of the display must also interconnect with the coating 5 to provide a substantially continuous 3-dimensional container for the circuitry. It is the maximum dimension of an aperture that determines the wavelength.

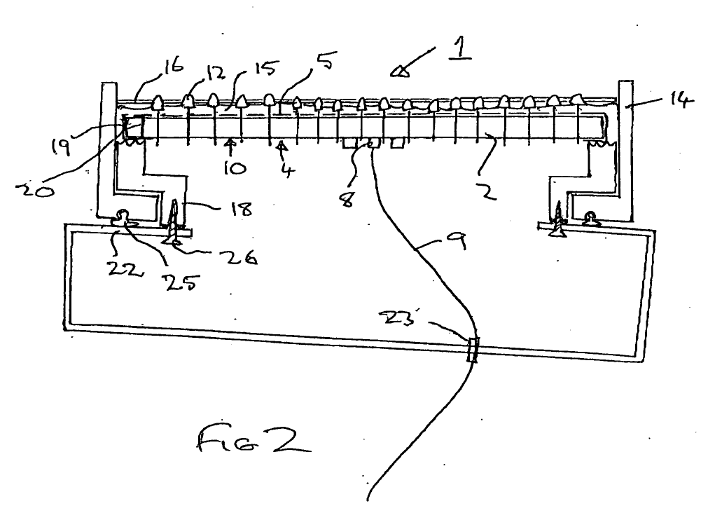

Referring to FIG. 2, a cross-section through a display screen 1 is provided. It should be noted that the cross-section shown is representative of a typical panel used as a subunit that is then interconnected with others to form an overall display screen. However it can also represent an entire display.

In this cross-section, the PCB 2 can be seen to have a reverse or rear face 4 on which various circuits 10 may be printed and driving components 8 and data and power cables 9 may be provided.

Generally such display units 1 have a PCB 2 carrying the light emitting elements 12 contained within a housing 14 surrounding the PCB 2. Various additional layers intermediate of the PCB 2 and light emitting elements 12 can be provided as may be preferred such as an epoxy layer 15 to waterproof the front face. A further layer 16 in the form of a cover containing louvers or similar for shading may also be provided.

To operate satisfactorily, the overall enclosure should avoid any apertures or gaps that have a dimension, even it is a single dimension of more than a few millimeters. For example, even if a preferred form protected the front and back of the PCB, sufficient radiation at potentially dangerous frequencies could emit from the edge of the PCB. Although the thickness of the PCB is not particularly large, the longer dimension in place with the PCB.

To cover this problem, it is recognized that it is insufficient to simply shield the front and rear of the PCB. Unless the shielding is substantially continuous around the PCB in three dimensions, difficulties will still be experienced. Hence it is necessary to ensure that a connection is provided around the perimeter of the PCB and the back cover. Furthermore this should be a substantially continuous connection or intermittent limited to relatively small gaps.

The preferred embodiment as shown in FIG. 2 provides an inner housing 18 that may progress around the perimeter of the PCB. In its preferred form, as it is desired to keep the distance between the edge of the PCB and the edge of the overall unit to a minimum to minimize the gap against an adjacent unit in a larger display screen, the inner housing 18 contacts the PCB on the rear face of the PCB. The inner housing 18 may be made from a conductive material or carry conductive parts so as to continue to provide a substantial continuous metallic enclosure around the component 3 on the rear face of the PCB.

To provide continuity between the PCB and the inner housing 18, the layer 5 may be progressed around the edge 19 of the PCB or, alternatively, a plurality of connections through the PCB or through apertures 20 can be provided. If apertures 20 are to be utilized, the width of the PCB is relatively small and provided the separation between adjacent apertures is also small, no large gaps will be available for the emission of electromagnetic noise.

The inner housing 18 would, most conveniently, be formed from a metallic material such as aluminum to be immediately conductive. The inner housing may then be provided with an electrically conductive substantially continuous connection to a rear housing 22 that may then entirely enclose the rear of the unit. Connection by screws or similar connectors 26 can bring the inner housing 18 and rear housing 22 into substantially continuous electrical connection around the panel. The rear housing 22 may contain apertures 23 suitable for the passage of data cables, power cables or other points of entry as required and again, provided the apertures are kept relatively small, there is no significant electromagnetic noise within unacceptable frequency ranges.

Rather than a solid housing 22, it is possible to utilize a mesh although with these screens generally being used for outer use, the solid housing is necessary for weatherproofing.

There may also be provided a sealant 25 to weatherproof the unit between the outer housing 14 and the rear housing 22. A continuous bead of silicon or similar may be used such that compression of the sealant allows firm contact to be maintained through the inner and rear housings.

In an alternative construction, mesh could be placed in connection with the inner housing 18 to enclose the circuitry and alternative housings could be used to entirely enclose the rear of the unit for weatherproofing such as non-metallic housings,

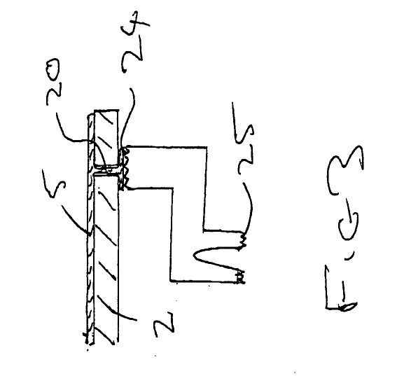

Referring to FIG. 3, an enlarged view of the connection between the inner housing 18 and rear housing can be shown. It can be seen that the inner housing may include textured surfaces 24 and 25 as desired such that, when the inner housing is placed against the PCB and the outer housing, an improved electrical connection may be formed.

The PCB may be secured directly to the inner housing 18 by way of screws or similar (not shown) or can be secured to any other point fixed to the rear housing 22 so as to substantially sandwich the inner housing between the rear housing 22 and the PCB.

Thus it can be seen that the present invention provides a substantially enclosed conductive box in which all the component 3 including the PCB may be maintained to reduce emission of electromagnetic noise.

The provision of a coating or layer on the front face of the PCB with apertures to allow connection of the light-emitting elements and the provision of a connection between that coating and a surrounding metallic housing forms the conductive volume in which the circuitry is placed.

Preferred embodiments of this invention have been described with reference to various integers which are determined to incorporate known equivalents where appropriate. The preferred embodiments are provided by way of example and should not be considered restrictive to the scope of the invention as defined in the appended claims.

1. A display screen comprising:
a printed circuit board (PCB) having a front face and a rear face;
a plurality of light emitting elements mounted on said PCB to reside on the front face of the PCB and provide a display;
control circuitry mounted directly or indirectly to said printed circuit board to drive said light emitting elements;
a layer of material conductive to electromagnetic radiation provided on a front face of said PCB to cover a substantial portion of said front face and positioned between said PCB and the light emitting portions of said light emitting elements;
a plurality of conductivity isolated areas in said layer to allow isolated connections from said light emitting elements to said PCB; and
a housing mounted around a perimeter of said PCB and extending around said driving circuitry containing material conductive to electromagnetic radiation to substantially enclose said driving circuitry within said housing and said layer.

2. A display screen as claimed in claim 1 wherein said layer of material conductive to electromagnetic radiation comprises a metallic layer deposited on said front face of said PCB.

3. A display screen as claimed in claim 1 wherein said housing mounted around a perimeter of said PCB is in substantially continuous conductive contact with said layer above said perimeter of said PCB.

4. A display screen as claimed in claim 3 wherein said housing includes an inner conductive housing engageable against an end or rear face of said PCB which is an electrical contact with said conductive layer on said front face of said PCB.

5. A display screen as claimed in claim 4 wherein a rear housing is connected to said inner housing to enclose said driving circuitry and said rear housing is made from a conductive material.

6. A method of reducing electromagnetic radiation from a display screen comprising:
providing a layer of electromagnetic conductive material on a front face of a printed circuit board used for mounting light emitting elements;
providing a plurality of electrically isolated points in or through said layer for the connection of said light emitting elements to said printed circuit board; and
surrounding a rear face of said printed circuit board with an electromagnetic conductive housing so as to substantially enclose driving circuitry behind the printed circuit board and the circuit board itself within a shield formed by said housing and said layer.
